(19) United States
(12) Patent Application Publication
(10) Pub. No.: US 2026/0007950 A1
(43) Pub. Date: Jan. 8, 2026

(54) BOARD GAME MECHANIC USING DRY ERASE MARKERS TO DENOTE PLAYER ACTIONS

(71) Applicant: Michael W. Wentz, Seattle, WA (US)

(72) Inventor: Michael W. Wentz, Seattle, WA (US)

(21) Appl. No.: 18/761,747

(22) Filed: Jul. 2, 2024

(51) Int. Cl. A63F 3/00; B43K 8/02; B43K 29/00; B43K 29/08

(52) U.S. Cl. CPC A63F 3/00694; B43K 29/00; B43K 29/08; A63F 2003/0093; B43K 8/024

(57) ABSTRACT

The present invention relates to an interactive board game system that enhances strategic depth and interactivity. The system includes a game board depicting various environments, overlaid with a clear, transparent sheet. Magnetic game pieces, placed on the game board under the transparent sheet, are marked with notations indicating orientation or area restrictions. A gaming wand, featuring a dry erase marker on one end and a magnet on the other, is used to draw action lines on the transparent sheet and to manipulate the magnetic game pieces. This setup allows players to dynamically move or rotate game pieces, denoting actions such as movement, attacks, and other interactions, while preserving the integrity of the game layout. The invention supports various game scenarios, accommodating players of different skill levels, and integrates elements of chance to enhance gameplay. This system provides a versatile and immersive gaming experience by combining traditional and innovative game mechanics.

### TECHNICAL FIELD

The present invention relates to game pieces and gaming apparatus, specifically to game pieces designed to move or rotate under a clear, transparent sheet. This invention addresses the need for game pieces that can dynamically orient themselves to display directional information and area restrictions during gameplay. The invention is applicable to various types of games, including but not limited to board games, strategy games, and tactical simulation games.

### BACKGROUND

Traditional game pieces used in board games and other tabletop games are typically static, lacking the ability to dynamically change orientation or directionality during gameplay. This limitation restricts the depth and complexity of strategic elements that can be incorporated into games. In many strategic and tactical games, the orientation and positioning of game pieces are crucial for determining outcomes based on directionality and area control, such as which way a weapon can fire, areas of vulnerability, and areas that are shielded from attack.

Existing game pieces that reside under a clear, transparent sheet (such as plastic, glass, or vinyl) generally do not possess the capability to move or rotate visibly to indicate their orientation or facing direction. This lack of functionality makes it challenging for players to keep track of complex positional and directional relationships between game pieces and the game board, thereby limiting the strategic depth and interactive experience of such games.

The present invention addresses these limitations by introducing a game piece that can move or rotate under a clear, transparent sheet while clearly indicating its orientation (e.g., front, back, left, right, port, starboard) and area restrictions. This innovation enhances the interactive and strategic elements of gameplay, providing players with a more immersive and dynamic gaming experience.

### SUMMARY

The present invention discloses a novel board game mechanic that utilizes dry erase markers to denote player actions, offering an innovative and interactive approach to tabletop gaming. The game features a “Play Area” game board with detailed graphics, which can depict various landscapes such as walls, roads, bodies of water, city blocks, medieval or sci-fi environments, golf courses, or outer space with asteroids. This game board serves as the central playing field for the game pieces and player actions. The game pieces are thin, magnetic units representing various player-controlled entities, such as cars, planes, spaceships, tanks, boats, people, or golf balls. These pieces are designed to be effectively magnetic and flat, which allows the gaming wand's felt-tip to move over them while they reside under a transparent laminate sheet. For optimal performance, the game pieces are ideally round or disk-shaped, such as a 0.01″ thick steel shim disks with a 0.5″ diameter. A transparent laminate sheet is placed over the game board and pieces, protecting the magnetic pieces from being disturbed during gameplay while still allowing players to interact with the play area using the gaming wand. The gaming wand itself is an elongate rod with a dry erase marker housed in one end (with the felt tip exposed) and a small magnet placed on the opposite end. This design enables the wand to serve dual functions: marking actions on the laminate surface and manipulating the magnetic game pieces beneath it. The game mechanic involves the player placing the gaming wand vertically on the play area with the felt tip down and the magnet end up, held in place by the player's fingertip. The player then moves their hand or finger off-center, causing the wand to become unstable and slide in the opposite direction. This movement draws a line on the laminate surface, dictating a variety of potential actions such as simulating game piece movement, shooting, or throwing projectiles, or generating random outcomes like dice rolls or spinner results. When a player needs to move a game piece, they flip the gaming wand, so the magnet end is facing downward. This allows the wand to attract the magnetic piece beneath the laminate sheet and move it to the desired location, often at the end of the line previously drawn. After performing the action, the player can easily erase the dry erase marker line with an eraser, paper towel, or cloth without disturbing the game pieces, thanks to the protective laminate sheet. The gaming wand comprises several components, including the dry erase marker, a plastic coupler that connects the marker to the rod, the magnet, and the rod or dowel itself. The coupler may feature a relief cut to better grasp the marker or be a simple tube design. Cross-sectional views of the couplers and measurement notations are included to facilitate accurate gameplay and distance measurement, with units marked on the side of the gaming wand. This inventive board game mechanic enhances player interaction, strategic planning, and the overall gaming experience by integrating dynamic movement and action recording with traditional tabletop gameplay elements.

In a specific embodiment of the disclosed invention, the interactive board game system is designed to provide a versatile and engaging gameplay experience by combining traditional board game elements with innovative features. The system includes a game board that can depict various thematic environments such as cityscapes, medieval landscapes, outer space, and sports arenas, offering diverse settings for different game scenarios. A clear, transparent sheet is positioned over the game board, serving as a protective layer that maintains the placement of the magnetic game pieces while allowing players to interact with the game through drawn lines. The magnetic game pieces, placed on the game board under the transparent sheet, are marked with notations indicating their orientation and/or area restrictions. These notations include directional indicators such as front, back, left, right, port, and starboard, which enhance the strategic depth by reflecting orientation and/or directional capabilities. Game pieces may also feature concentric circles or other markings indicating different target zones, allowing for varying degrees of difficulty and damage based on which zone is hit by a player's action. Unique identifiers like color codes, symbols, or alphanumeric characters differentiate between different units or players, facilitating individualized gameplay and tracking of game pieces. Additionally, the game pieces can be constructed from materials with varying thicknesses or textures to represent different types of terrain or obstacles, adding a tactile element to the gameplay experience. The preferred gaming wand is an elongate rod (e.g., cylindrical rod) with a dry erase marker at one end and a magnet at the opposite end. The dry erase marker is used to draw lines on the transparent sheet to denote player actions, including movement, attacks, and other interactions. The magnet end of the wand manipulates the magnetic game pieces by at least moving and/or rotating them under the transparent sheet, facilitating precise positioning and alignment on the game board. The marker also includes measurement notations along the length of the rod, allowing players to accurately measure distances and movements during gameplay. To enhance gameplay, the system includes a set of randomization elements such as multi-sided dice, which introduce elements of chance and variability to determine the outcomes of player actions and movements. Predefined templates can also be placed under the transparent sheet, providing structured scenarios, missions, or challenges that guide player actions and objectives. The transparent sheet itself is treated with a special coating to enhance the visibility of dry erase markings and to facilitate easy cleaning and erasing without smudging. The sheet may also feature predefined grid markings to assist in the precise alignment and positioning of the magnetic game pieces, improving the accuracy of gameplay actions and strategy implementation. To ensure consistent and stable interaction with the game pieces, the transparent sheet can be secured to the game board using clips, magnets, or other fastening mechanisms, preventing it from shifting during gameplay. This comprehensive setup allows for dynamic and strategic gameplay, offering a rich and immersive experience for players of all skill levels.

These and other features and advantages of the present invention will become apparent from the detailed description below, considering the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Having thus described the invention in general terms, reference will now be made to the accompanying drawings, which are not necessarily drawn to scale, and wherein:

FIGS. 1-10 illustrate various schematic drawings that support the detailed explanation of the board game mechanic using dry erase markers to denote player actions, in accordance with various embodiments of the present invention.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth to provide a thorough understanding of the present technology. It will be apparent, however, to one skilled in the art that the present invention can be practiced without these specific details. In other instances, structures and components are shown in block diagram form only to avoid obscuring the present disclosure.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Reference will now be made in detail to selected embodiments of the present disclosure in conjunction with accompanying figures. Among various embodiments, the board game mechanic using dry erase markers to denote player actions has been disclosed. The embodiments' described figures are intended and provided to illustrate embodiments of the disclosure described below and are not necessarily drawn to scale. In the drawings, like numbers refer to like elements throughout, and the thicknesses and dimensions of some components may be exaggerated for providing better clarity and ease of understanding. Further, the terms “a” and “an” herein do not denote a limitation of quantity, but rather denote the presence of at least one of the referenced items.

Traditional games face limitations due to static game pieces and the inability to dynamically illustrate complex player actions and strategic maneuvers. Players often struggle with maintaining the orientation and/or positional relationships of game pieces, which can diminish the depth and interactivity of the gaming experience. The present invention addresses these issues by introducing a board game mechanic that utilizes a transparent laminate sheet covering the game board, dry erase markers for action notation, and magnetic game pieces. This solution allows for real-time adjustments and precise movement of game pieces without disrupting the overall setup. The gaming wand, equipped with a dry erase marker on one end and a magnet on the other, enables players to draw action lines on the laminate surface to depict movements, projectile paths, or other actions, while the magnetic end can manipulate the pieces underneath. This innovative approach ensures that strategic elements such as directionality, movement, and interactions between pieces are clearly communicated and easily managed, enhancing the strategic depth and immersive quality of tabletop games.

The present invention offers numerous advantages for gaming. The use of a transparent laminate sheet over the game board protects magnetic game pieces from being disturbed while allowing for clear visibility and interaction. The dry erase markers enable easy notation of player actions, facilitating dynamic and flexible gameplay. The magnetic game pieces and gaming wand allow for precise and controlled movements, enhancing the strategic depth and realism of the game. This mechanic supports a wide variety of actions, such as simulating movement, projectile paths, and generating random outcomes, providing a versatile and engaging player experience. Additionally, the ability to quickly erase and redraw action lines promotes a clean and organized play area, making it easier to track ongoing game states and strategies. The overall design encourages creativity and innovation in game design, allowing for complex and interactive gameplay scenarios that were previously difficult to implement with traditional game pieces.

The innovative game mechanic is versatile and can be applied to a wide range of tabletop and board games. In strategy and tactical games, such as war simulations or role-playing games, the precise movement and action notation can represent troop movements, battle tactics, and area control. In sports-themed games, like golf or football, the mechanic can simulate the trajectory and impact of balls or players. Sci-fi and fantasy games can benefit from depicting spaceship maneuvers, spellcasting ranges, or area-of-effect attacks. The system is also ideal for educational games, where precise positioning and action notation can enhance learning experiences, such as in geography or history simulations. The flexibility of the mechanic allows it to be adapted for both competitive and cooperative games, making it suitable for a wide audience and various game genres. Whether used in classic board game settings or innovative new game designs, this mechanic enhances interactivity, strategy, and player engagement.

The present invention discloses a comprehensive interactive board game system designed to provide a dynamic and engaging gameplay experience. The system combines traditional board game elements with innovative features that enhance strategic depth and player interactivity. The game board serves as the primary playing surface and can depict various thematic environments such as cityscapes, medieval landscapes, outer space, or sports arenas. These themes are represented using vibrant colors and detailed graphics to immerse players in the game's setting. A clear, transparent sheet made of plastic, vinyl, or glass is placed over the game board. This sheet acts as a protective layer, keeping the game pieces in place while allowing players to draw action lines on its surface. The sheet can have a special coating to enhance visibility of the dry erase marker and facilitate easy cleaning without smudging. The game pieces are thin, flat, and magnetic, enabling them to move or rotate under the transparent sheet. The one or more game pieces may be marked with specific notations indicating orientation (front, back, left, right, port, starboard) or area restrictions (e.g., firing arcs, shielded zones). These pieces may also include unique identifiers like color codes, symbols, or alphanumeric characters to differentiate between different units or players. The game pieces can be constructed from materials with varying thicknesses or textures to represent different types of terrain or obstacles. The gaming wand is an elongate rode rod with a dry erase marker at one end and a small magnet at the other. The wand is used to draw lines on the transparent sheet, representing player actions such as movement, attacks, and other interactions. Measurement notations along the length of the rod allow players to accurately measure distances and movements. The magnet end of the wand facilitates precise manipulation of the game pieces underneath the sheet, ensuring controlled and accurate positioning. Players use the dry erase marker to draw lines on the transparent sheet, denoting their intended actions. For example, a player might draw a line to indicate the movement path of a game piece or the trajectory of a projectile. These lines can intersect or terminate in specific zones on the game pieces, triggering different effects based on the game's rules. Using the magnet end of the gaming wand, players can move or rotate the magnetic game pieces beneath the transparent sheet. This allows for precise adjustments in positioning and orientation, which are crucial for executing strategic maneuvers. For instance, a piece may need to be rotated to face a particular direction before an attack can be executed. The game pieces can feature concentric circles, directional indicators, and vulnerability zones. For example, expert players might need to target smaller inner circles for higher damage, while beginners can aim for larger outer circles. Directional indicators show which way the pieces are facing, and vulnerability zones highlight areas where pieces are susceptible to attacks. To introduce elements of chance, the system includes randomization tools such as multi-sided dice. Players roll the dice to determine the outcomes of certain actions, adding variability and excitement to the game. Additionally, predefined templates can be placed under the transparent sheet to guide player actions with structured scenarios, missions, or challenges.

Practical Color Scheme may be associated with one or more of: (1) Game Board: Uses vibrant and thematic colors to represent different environments, enhancing visual appeal and immersion, (2) Transparent Sheet: Clear to ensure full visibility of the game board and pieces, possibly with grid markings or subtle color tones for added guidance, (3) Game Pieces: Color-coded for easy identification and differentiation. Unique identifiers like symbols or alphanumeric characters are used to distinguish between different units or players, and (4) Dry Erase Marker: Typically, black or another dark color to ensure high contrast and visibility on the transparent sheet.

By integrating these components and mechanics, the interactive board game system offers a versatile and immersive gameplay experience. Players can engage in complex strategic planning, precise movement, and dynamic interactions, making the game suitable for a wide range of scenarios and player skill levels. The innovative use of dry erase markers and magnetic pieces under a transparent sheet ensures that the game remains organized and visually appealing while providing ample opportunities for creativity and strategic depth.

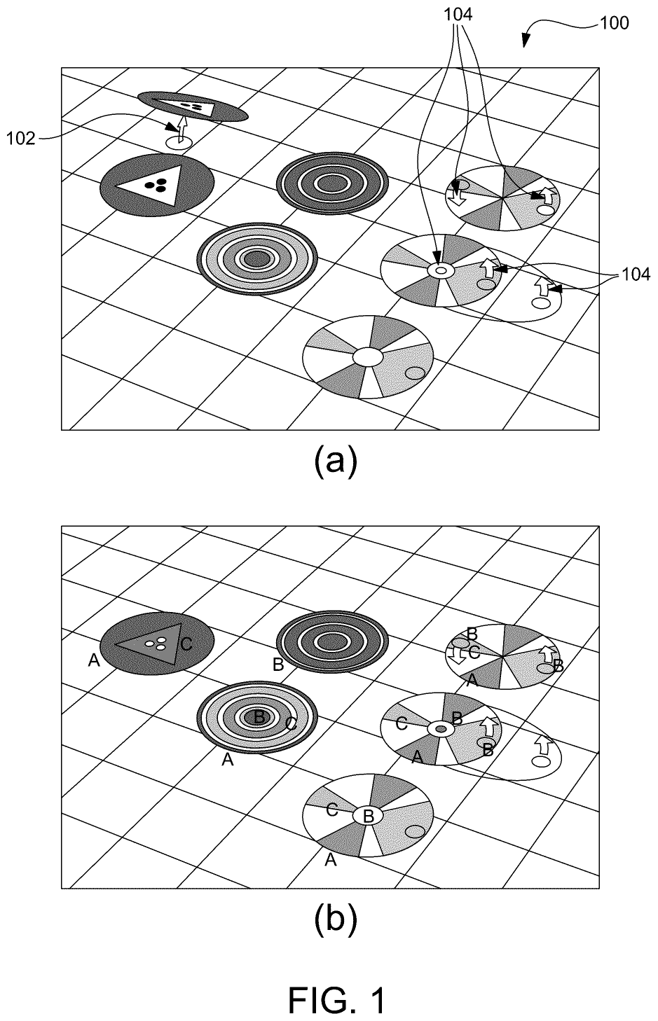

Now the present invention will be described in detail with reference to illustrated drawings FIGS. 1 to 10.

FIGS. 1-10 illustrate various schematic drawings that support the detailed explanation of the board game mechanic using dry erase markers to denote player actions, in accordance with various embodiments of the present invention. In an exemplary embodiment, FIGS. 1(a) and (b) are diagrams that shows game piece construction. In FIG. 1(a), the orange arrow illustrates the placement of a magnetic element (which can be ferromagnetic or magnetic) underneath the game piece making it a magnetic gamepiece. This metal component allows the magnetic game piece to be manipulated by the magnetic end of the gaming wand, enabling precise movement across the game board while under the transparent laminate sheet. It should be clear that any combination of magnetic and ferromagnetic elements in either the game piece or wand that serve to provide a magnetic attraction between the two are sufficient for the purposes of the game mechanic. The yellow arrows and dot indicate the pivot points or rotational directions for the game piece. These points show how the game piece can rotate around specific axes, allowing it to change its orientation to reflect different strategic positions and directional relationships during gameplay.

In FIG. 1(b), the labeled parts detail the construction of the game piece:
A—plastic, paper, etc. game piece token: this refers to the main body of the game piece, which can be made from various materials such as plastic or paper, providing the physical form of the piece.
B—metal (ferrous or magnetic): this component is placed underneath the game piece and is crucial for magnetic interaction with the gaming wand. It allows the piece to be moved and/or positioned accurately on the game board.
C—printed surface noting functional, utility graphics: this layer includes printed graphics that denote important functional or utility information relevant to gameplay, such as symbols, numbers, or directional indicators.
D—etched/powder coated/etc. surface noting functional, utility graphics: this refers to additional surface treatments, like etching or powder coating, which also provide functional and utility graphics. These treatments can enhance durability and visual clarity.
E—transparent plastic to make rotation of game piece easier: this component is a transparent plastic layer that facilitates the smooth rotation of the game piece. It reduces friction, allowing the piece to pivot and turn easily when manipulated by the player.

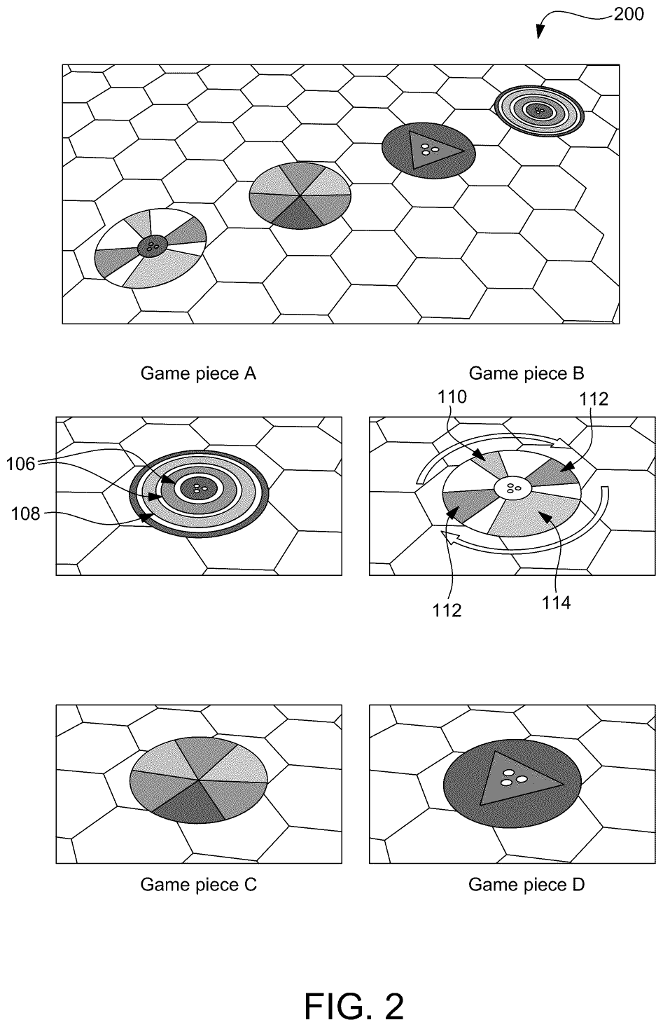

FIG. 2 showcases a few variations of the game piece, all flat game pieces that can be manipulated with a magnet and have one or two of these primary qualities: a graphic that notes a specific game piece that correlates to specific game rules unique to the game piece (here noted with three dots, but can also include color coding, letters, symbols and the like (described in better detail below; GAMEPIECE D)), and/or directionality (allowing for the game piece to be oriented to the gameboard and to other game pieces).

GAMEPIECE A exhibits concentric circles that can be used for a variety of uses, such as: (1) Advanced players can use the inner white circle, designating a smaller target to determine a successful attack—while Novice players can use the larger, outer white circle, allowing for easier attacks. (2) A successful attack to the inner circle can yield more damage to the unit, while outer circles would cause less damage.

GAMEPIECE B can rotate via magnets and exhibits areas that designate both the directionality of the ship (in this example, the BLUE area shows the game piece's forward direction), the areas where the ship can attack from (here, the RED areas show the game piece can fire projectiles from its port and starboard sides), and where the game piece is vulnerable to attack (any incoming attack that passes through the green area will deal bonus damage). These notations can vary in visual appearance and dictate many other unique values the game piece might have (such as movement constraints, special attacks, etc.).

GAMEPIECE C can be used for randomization of movement or action. In this case, the game piece is bisected into 6 equal portions. Coupled with a roll of a 6-sided die, a player can determine which direction this piece can move, fire weapons, or perform any other directional actions using the game wand. This could be used for practical in-game scenarios, such as the random bounce of a football, the movement of a non-player unit, etc.

GAMEPIECE D denotes a specific unit (expressed in the above game pieces, as well), differentiating itself from other game pieces. The primary use of this game piece is to connect it to statistics that specifically link to the game piece on the board.

FIG. 2 also illustrates the TRIANGLE game piece with three dots, corresponding to a designated area on the game board labeled as a Fighter.

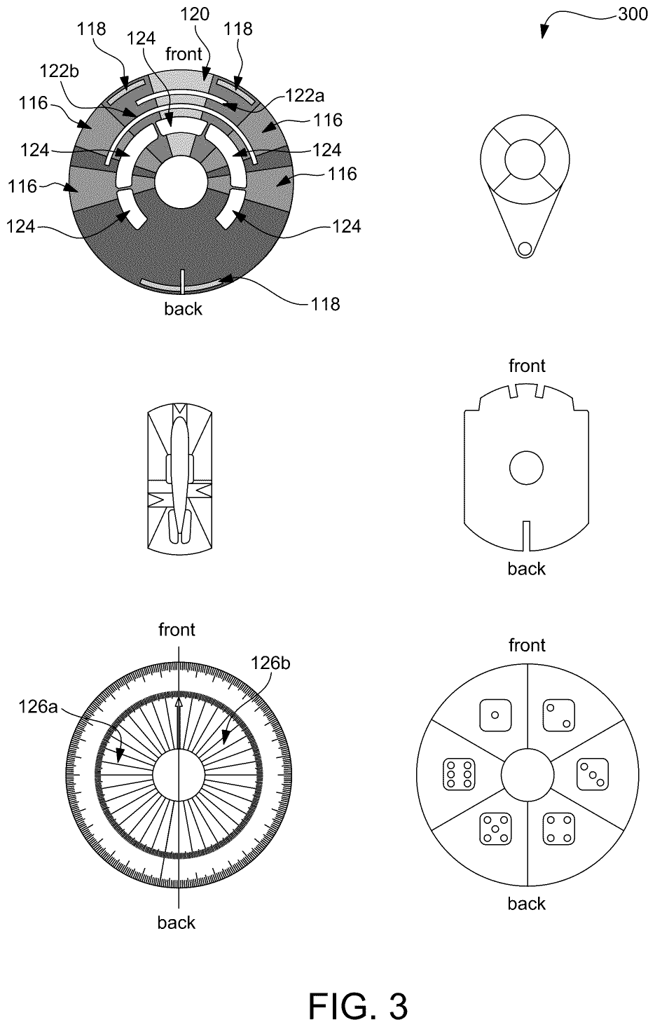

FIG. 3 illustrates game piece examples. This game piece shows a variety of examples that are used to dictate how lines made on the clear sheet can both originate from and interact with the game piece. For example: The YELLOW graphic is used to dictate where an attack from the game piece may originate. The BLUE graphic represents the game piece's shield, nullifying any incoming attack. The RED could specify an Army sniper's rifle, limiting their area of attack to the forward position. The WHITE could dictate flight movement. A line can be made from the narrower white bar for fast movement, while the wider white bar dictates a slower movement due to a tighter turn made by a plane. The 5 GREY zones dictate damage incurred from incoming fire. If an opponent's line crosses over one of the five zones and scores a hit on the primary area, the player will receive the damage bonus noted.

Graphics are not the only way to denote the game piece's orientation. In this example, the shape of the game piece is used to orient the game piece. The notches can be used to show the front and back of the unit/game piece, as well as other capabilities and spatial restrictions dictated by the game's rules.

This game piece notes F (Front), B (Back), L (Left), and R (Right). It is rotated under the clear, transparent sheet by a second magnet outside of the primary area. The four segments on the game piece can be used to dictate how lines are made on the clear sheet, dictating incoming and outgoing actions (game piece's actions as well as incoming lines).

The game piece shows various numbers and letters, as well as being color-coded, to provide a wider array of game options. In this example, a compass using 360 individual points, along with blue and red color-coded hemispheres, can relate to a variety of gaming options and orientations. As an example: Between 70 and 120, the player is vulnerable to attack, allowing incoming attacks to have a 50% damage bonus to the unit. The game piece has lost all attack power on the blue side of the ship (unit). They can only fire from the red side. This game piece notes the many specific areas of a modern-day battleship. The RED area notes offensive directional capabilities, the GREEN for engine location, BLUE for command crew location, and other HIGHLIGHTED AREAS for additional orientation/directional properties that can be used for multitudes of gameplay mechanics.

Game pieces can have multiple-sided die outcomes represented (4, 6, 8, 10, 12, 20, 100 etc. sided dice). Here, a standard 6-sided die is shown. For any occasion needed by the game rules, a player could roll the dice and must follow the result when making a line with the marker to dictate a move, fired weapon, special action, etc. As an example, a grenade lands after being thrown by a player's game piece, hitting uneven terrain. The grenade will take an odd bounce before exploding. The attacking player rolls a 3, directing the grenade's change in direction before it detonates.

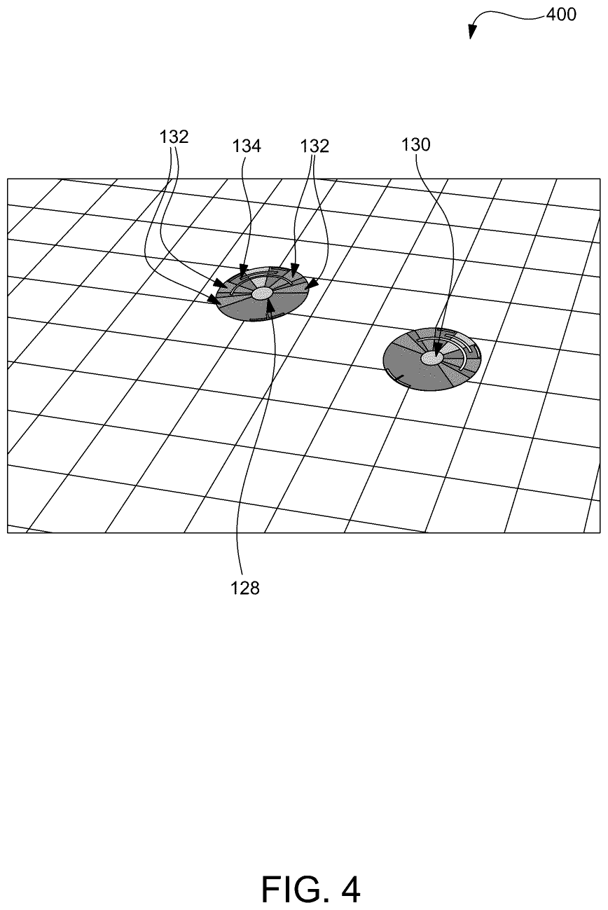

In FIG. 4, the blue player wants to shoot the red player with their side cannon (indicated by the yellow areas of attack), but they are not currently able to do so. To improve their positioning, they choose to attempt a move using the smaller white graphic on the game piece's field. This allows them to use a longer gaming wand, which enables faster movement over a greater distance. The white and yellow highlights on the gameboard are for illustrative purposes only, showing the extended area of move or attack available to the blue player. The goal is to attain better positioning for the shot.

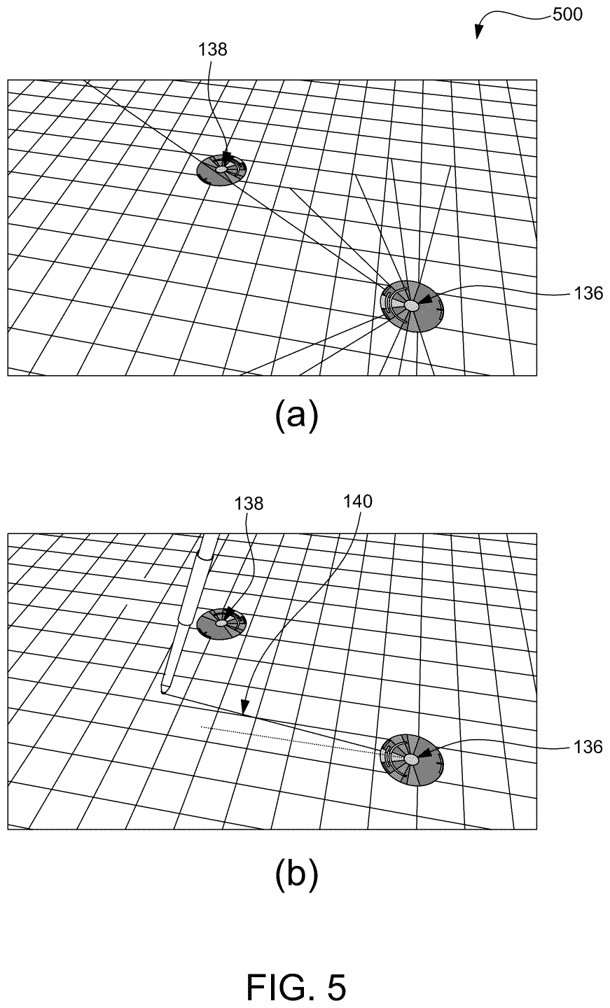

In the FIG. 5(a), the scenario describes a blue player attempting to shoot a red player using their side cannon, which is indicated by the yellow areas of attack. However, the blue player is currently not in a favorable position to make this attack. To improve their position, they decide to use the smaller white graphic on the game piece's field. This action allows them to employ a longer gaming wand, facilitating a faster and farther movement across the board. The goal is to reposition the blue game piece for a better angle and distance to execute the shot effectively. The white and yellow highlights on the game board are for illustrative purposes only. They show the potential extended area of movement or attack that is available to the blue player, visually representing how the blue player can navigate the game piece to achieve a tactical advantage. This visual aid helps in understanding the strategic possibilities provided by the game mechanics.

In FIG. 5(b), the blue player successfully executes a move within the constraints of the smaller white graphic's parameters on the game piece. This successful move is visually demonstrated by the line created by the gaming wand. However, the line ends slightly to the right of the game piece's true forward trajectory, which is illustrated by a dotted line. As a result, the game piece will need to rotate slightly after the move to properly align with its intended direction. To achieve this alignment, the small black line on the back of the game piece is utilized, ensuring that the piece is correctly oriented according to the game rules. This example highlights the precision required in positioning and orienting game pieces during gameplay, emphasizing the importance of visual indicators and alignment tools on the game pieces.

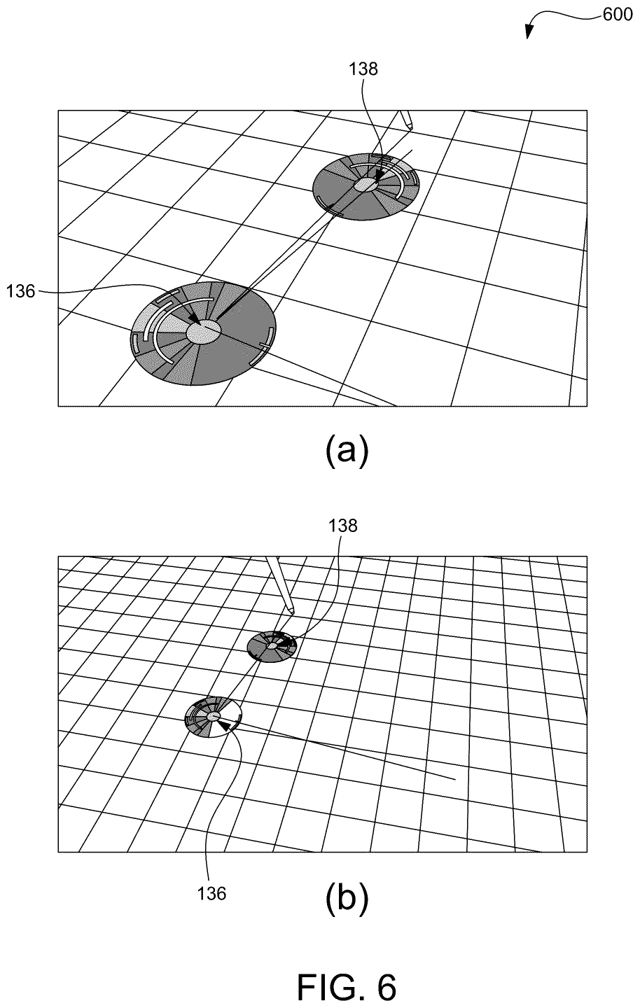

In FIG. 6(a), the scenario demonstrates a potential shot trajectory in a game involving two players, Blue and Red. The Blue player attempts to make a shot at the red player using the side cannon (indicated by the yellow areas of attack on the game pieces). The lines drawn on the game board illustrate the trajectory and alignment necessary for the shot. If the blue player had successfully made this shot, the red player would have been hit and incurred damage. The figure shows the precise alignment and trajectory required for a successful hit, emphasizing the strategic positioning and movement needed to execute such an action within the game. This visual example highlights the importance of accurate positioning and alignment of game pieces to achieve successful attacks and inflict damage on opponents.

In FIG. 6(b), the scenario details the actions taken by the blue player after successfully shooting into the red player's shield. Following this successful attack, the blue player decides to move their ship. To execute this maneuver, they choose to make a tight turn. The Blue player uses the wider white line on the game piece to dictate the tightness of the turn. The wider white line allows for a precise and controlled turn, ensuring that the movement adheres to the game's rules regarding turning radii. The player then makes the necessary line on the game board to represent this move action. This example illustrates the strategic use of the game piece's graphics and parameters to perform specific maneuvers, showcasing how the design elements of the game piece (such as the wider white line) are employed to facilitate detailed and rule-compliant movements during gameplay.

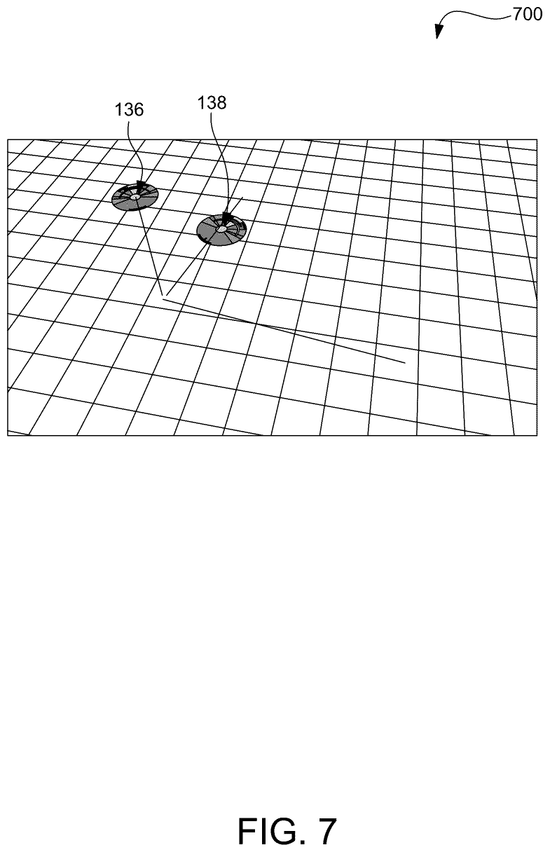

In FIG. 7, it describes the movement and orientation of the blue player's ship. The player moves their blue ship, which resides under a clear, transparent sheet, to the end of the drawn line. After moving the ship, the player rotates the game piece to properly orient the ship, reflecting its new direction. This movement and rotation illustrate how the blue player's game piece is now oriented differently in relation to the game board, other game pieces, and the overall gameplay environment. This action demonstrates the dynamic nature of the game, where game pieces can be moved and/or reoriented precisely, maintaining strategic positioning and alignment according to the game rules. The clear, transparent sheet ensures that the game piece remains undisturbed during this process, providing a seamless and accurate adjustment to the game state.

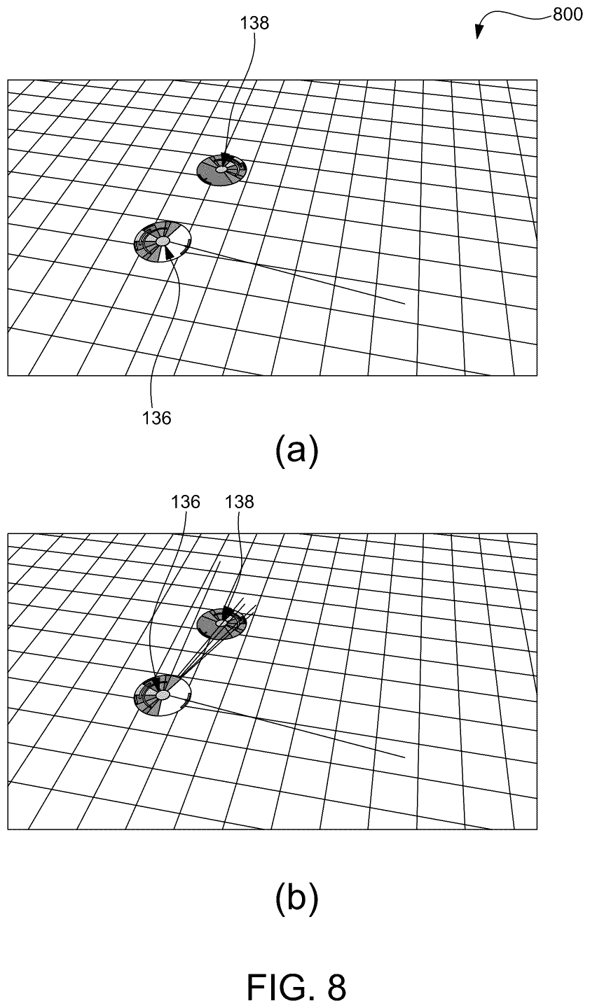

In FIG. 8(a), it describes the blue player's action of at least moving and/or rotating their game piece. The player aligns the end of the drawn line to the middle of the game piece, specifically using the small black mark as a reference point. This alignment ensures that the ship is oriented correctly into its intended position. The process involves precisely positioning the game piece so that it aligns with the black mark, which serves as an indicator for proper orientation. This detailed maneuver allows the blue player to maintain accurate positioning and directionality of their ship in relation to the game board and other game pieces, demonstrating the importance of the black mark for achieving correct alignment during gameplay.

In FIG. 8(b), it explains the tactical situation of the blue player who is now in position to attack the red player. However, the red player's shield (indicated by the blue lines on the red player's game piece's field) limits the blue player's chances of scoring a clean hit. The figure highlights the area of attack presented by the yellow graphic on the blue player's game piece, which represents the firing arc of the cannon. The denser yellow highlight shows the precise margin for a successful attack, considering the shield and the size of the red player's ship, as indicated by the red circle on the game piece. This illustration emphasizes the narrow window through which the blue player must aim to hit the red player's ship effectively, demonstrating the strategic depth and precision required in positioning and executing attacks in the game.

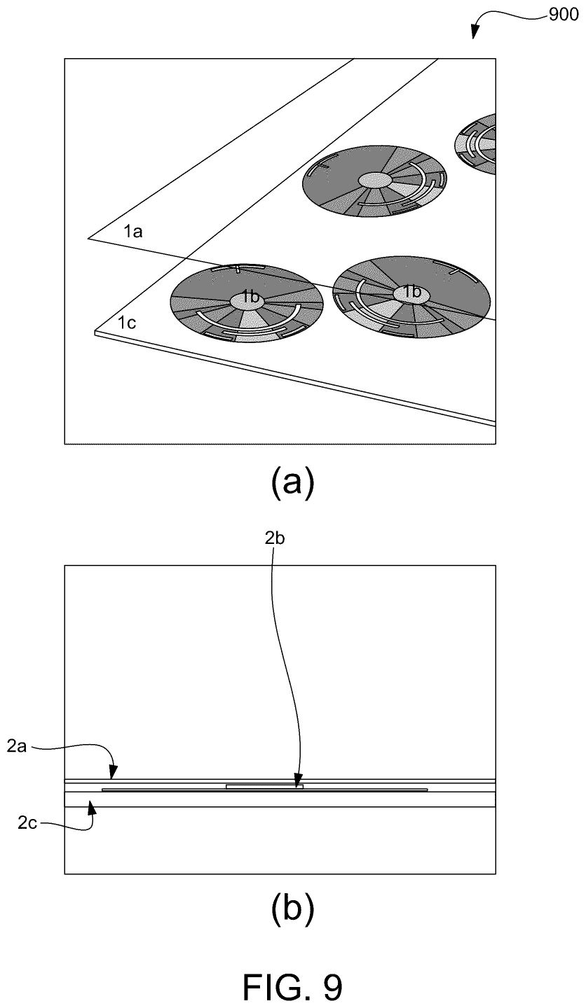

In FIG. 9, a game piece is used in a board game that resides under a clear, transparent sheet and above a gameboard, effectively “sandwiched” between the two. The game piece is employed in conjunction with a board game that uses drawn lines on top of the clear, transparent sheet to denote various actions such as a player's move, attack, or any miscellaneous actions. The game piece under a clear, transparent sheet (which can be made of materials like plastic, vinyl, glass, etc.) is designed to move or rotate to orient itself to the gameboard and other game pieces. The game piece indicates its orientation (front, back, left, right, port, starboard, etc.) and includes area restrictions, such as which direction a gun can fire, or which part of the game piece is shielded from attack. In FIG. 9(a), “1a” shows clear, transparent Sheet: This sheet hovers above the gameboard and game pieces for illustration purposes, showing how it covers the game setup; “1b” shows game pieces: These are examples of game pieces with notations that denote their orientation markings, illustrating how the one or more game pieces may indicate directionality and positioning; and “1c” shows gameboard: Depicted in white or gray for illustration purposes, the gameboard can have various graphics or colors to enhance gameplay and thematic elements. In FIG. 9(b), “2a” shows clear, transparent sheet: In its final placement for gameplay, this sheet covers both the gameboard and the game pieces, ensuring they remain in position during play; “2b” shows game pieces: These pieces are placed upon the gameboard and underneath the transparent sheet, allowing for smooth interaction without being displaced; and “2c” shows gameboard: Positioned at the bottom, resting on the “table-top,” providing a stable foundation for the game setup. This detailed setup demonstrates how the clear, transparent sheet functions to protect and maintain the position of the game pieces while allowing for interactive gameplay through drawn actions on its surface. The notations on the game pieces facilitate precise orientation and/or area restriction management, enhancing the strategic depth of the board game.

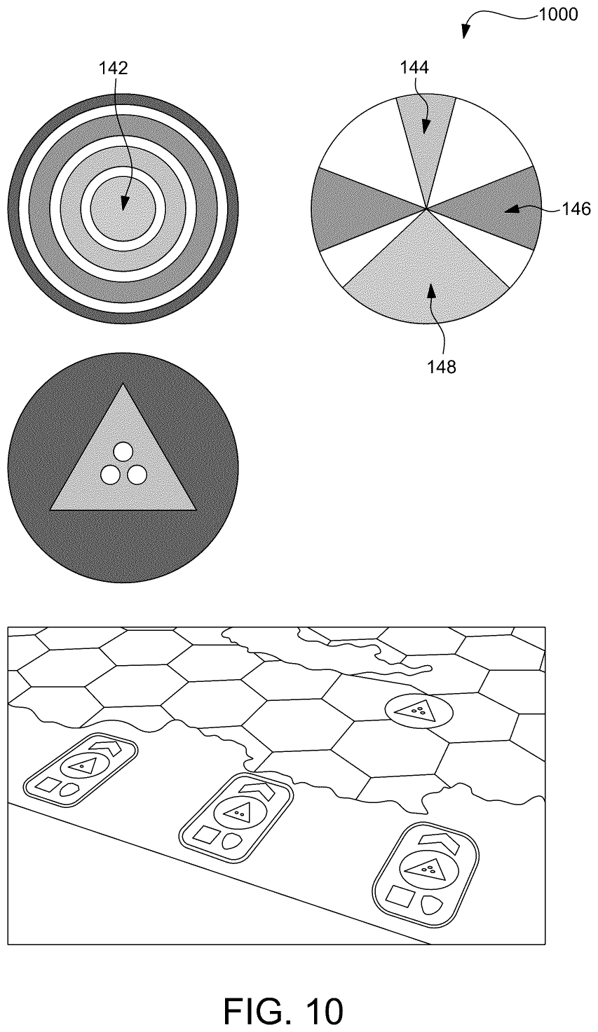

FIG. 10 illustrates the use of dry erase game pieces with graphic notations that provide detailed information on targeting, movement, and vulnerability. The notations allow for varying levels of gameplay complexity based on player expertise. By marking different areas on the game piece, the players can understand the potential impact of their actions, such as targeting specific zones for maximum damage or identifying vulnerable points on an opponent's piece. This enhances the strategic depth and tactical decision-making in the game, making it suitable for both novice and experienced players.

FIG. 10 shows:
1. Concentric Circle Target
Expert Players: Need to cross the center white circle to hit the unit with a shot.
Advanced Players: Need to cross the second largest white circle to hit.
Beginner Players: Only need to hit the larger, outer white circle to score a hit.
This graphic can also be used as a target, where:
Green Area: Lines that terminate here do the most damage.
Outer Areas: Lines that terminate here do less damage or trigger a different in-game effect.
2. Directional and/or Functional Areas
Blue Area: Dictates where the ship can move and illustrates the front of the ship/unit.
Red Area: Indicates where a line can be made to fire its side cannons.
Green Area: Shows where the ship is vulnerable to attack if a line passes through this area.
These areas can be configured in various ways to represent specific, directional gameplay rules and effects.
3. Specific Unit Notation
This graphic denotes a specific unit, differentiating it from other game pieces. The primary use of this game piece is to link it to specific statistics on the game board.

In summary, the disclosed invention pertains to an innovative board game mechanic that utilizes dry erase markers, magnetic game pieces, and a clear, transparent sheet to create a dynamic and interactive gaming experience. This system enhances the strategic depth and realism of tabletop games by allowing precise movement, orientation, and action notation of game pieces. The game board can depict various environments such as cityscapes, medieval landscapes, or outer space. A clear, transparent sheet (made of materials like plastic, vinyl, or glass) is placed over the game board, providing a protective layer that keeps the game pieces in place while allowing players to interact with them using a dry erase marker. The magnetic game pieces are thin, flat, and designed to move or rotate under the transparent sheet. They represent various units, such as cars, planes, spaceships, tanks, and people, and are marked with notations indicating their orientation (front, back, left, right, port, starboard) and area restrictions (e.g., firing arcs, shielded zones). A critical component of the system is the gaming wand, a thin, elongate rod (e.g., a cylindrical rod) featuring a dry erase marker at one end and a small magnet at the other. Players use the wand to draw lines on the transparent sheet, representing actions such as movement, projectile paths, or other tactical maneuvers. The magnetic end allows players to move the game pieces underneath the sheet, facilitating precise repositioning. The game mechanics involve players drawing lines on the clear sheet to denote actions. For instance, the length and direction of a line can represent the movement of a game piece or the trajectory of a projectile. The game pieces can rotate to reflect changes in orientation, with specific markings indicating directionality and functional zones. Randomization elements such as dice rolls can be integrated to determine actions and movements. This invention offers numerous advantages. Enhanced interactivity is a key benefit, as the clear, transparent sheet allows for seamless interaction with the game pieces, enabling players to draw and erase action lines without disturbing the underlying setup. The use of dry erase markers makes it easy to adjust and change actions dynamically during gameplay. Strategic depth is significantly increased through the magnetic game pieces and their ability to rotate and move precisely, requiring players to consider orientation, positioning, and area restrictions when planning their moves. This leads to a more engaging and challenging experience. The system's versatility is another major advantage. It can be applied to various types of games, including strategy games, tactical simulations, sports-themed games, and educational games. Different game piece notations and configurations can be tailored to specific game rules and themes, offering flexibility in game design. Accessibility is also enhanced, as the game accommodates players of different skill levels. Expert players can target smaller, more challenging zones, while beginners can aim for larger, easier targets, ensuring that both novice and experienced players can enjoy the game. Additionally, the transparent sheet protects the game pieces, preventing them from being displaced during play, and the use of magnetic pieces and the gaming wand ensures controlled and precise movements, maintaining the integrity of the game setup. Example scenarios illustrate the system's functionality. Game pieces can have concentric circles where different levels of players target specific zones to inflict varying degrees of damage. Lines terminating in different areas can trigger distinct effects or outcomes. Game pieces can have sectors indicating movement capabilities, firing arcs, and vulnerability zones, and players use the gaming wand to draw lines that represent these actions, rotating the pieces to align with the drawn paths. Specific game pieces can be marked to denote unique units with corresponding statistics tracked on the game board, allowing for complex interactions and role-specific gameplay mechanics. Overall, this invention revolutionizes traditional board games by integrating dynamic movement, precise action notation, and strategic gameplay, providing an immersive and interactive experience for players.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

1. An interactive board game system comprising:
a game board depicting various environments for gameplay;
a clear, transparent sheet positioned over said game board;
a plurality of magnetic game pieces placed on said game board and under said transparent sheet, wherein one or more game pieces from the plurality of magnetic game pieces have notations indicating area restrictions; and
a magnetic gaming wand comprising an elongate rod, a dry erase marker at one end, and a magnetic element at the opposite end,
wherein said dry erase marker is used to draw lines on said transparent sheet to denote player actions including movement, attacks, and other interactions, and
wherein said magnetic wand is used to manipulate said magnetic game pieces by moving or rotating them under said transparent sheet, facilitating precise positioning and alignment on said game board.

2. The interactive board game system of claim 1, wherein said game board is configured to depict various themes, including but not limited to cityscapes, medieval landscapes, outer space, and sports arenas, providing versatile environments for different game scenarios.

3. The interactive board game system of claim 1, wherein at least one of said magnetic game pieces includes concentric circles indicating different target zones, allowing for varying degrees of difficulty and damage depending on which zone is hit by a player's action.

4. The interactive board game system of claim 1, wherein said notations on said magnetic game pieces include directional indicators such as front, back, left, right, port, and starboard, enhancing the strategic depth by reflecting orientation or directional capabilities.

5. The interactive board game system of claim 1, further comprising a set of randomization elements, including multi-sided dice, to determine the outcomes of player actions and movements, thereby introducing elements of chance and variability into the gameplay.

6. The interactive board game system of claim 1, wherein said game board includes predefined grid markings to assist in the precise alignment and positioning of said magnetic game pieces, improving the accuracy of gameplay actions and strategy implementation.

7. The interactive board game system of claim 1, wherein said magnetic game pieces include unique identifiers, such as color codes, symbols, or alphanumeric characters, to differentiate between different units or players, facilitating individualized gameplay and tracking of game pieces.

8. The interactive board game system of claim 1, wherein said dry erase marker on the gaming wand includes measurement notations along the length of the elongate rod, allowing players to accurately measure distances and movements during gameplay.

9. The interactive board game system of claim 1, wherein the transparent sheet is treated with a special coating to enhance the visibility of dry erase markings and to facilitate easy cleaning and erasing without smudging.

10. The interactive board game system of claim 1, further comprising a set of predefined templates that can be placed under the transparent sheet, providing structured scenarios, missions, or challenges that guide player actions and objectives.

11. The interactive board game system of claim 1, wherein said magnetic game pieces are constructed from materials with varying thicknesses or textures to represent different types of terrain or obstacles, adding a tactile element to the gameplay experience.

12. The interactive board game system of claim 1, wherein the transparent sheet is secured to the game board using clips, magnets, or other fastening mechanisms to prevent shifting during gameplay, ensuring consistent and stable interaction with the game pieces.

13. The interactive board game system of claim 1, wherein the one or more game pieces from the plurality of magnetic game pieces have notations indicating orientation.
